(19) United States
(12) Patent Application Publication
(10) Pub. No.: US 2021/0239237 A1
(43) Pub. Date: Aug. 5, 2021

(54) Tow-Behind Rotary Spreader Driver Seat Operated Discharge Chute Control

(71) Applicants: GARY MICHAEL PETRILLO, SR., WALLINGFORD, CT (US); GARY MICHAEL PETRILLO, JR., NORTH HAVEN, CT (US)

(72) Inventors: GARY MICHAEL PETRILLO, SR., WALLINGFORD, CT (US); GARY MICHAEL PETRILLO, JR., NORTH HAVEN, CT (US)

(21) Appl. No.: 16/890,283

(22) Filed: Jun. 2, 2020

Related U.S. Application Data
(63) Continuation-in-part of application No. 16/780,991, filed on Feb. 4, 2020.

(51) Int. Cl. F16K 31/46; A01C 15/12

(52) U.S. Cl. CPC F16K 31/465; A01C 15/124

(57) ABSTRACT

This abstract is based on an alternate, improvement control method, to assist the drivers who have had, or recently discovered they have hand or finger disabilities and can no longer use our easy grab ball control disc, because it is too difficult for them to pull against some of the low-end spreader models that use very heavy springs to keep the tow-behind spreader center-column-handle-lever in place, each time the slide gate porthole chute is repositioned.

This alternate control method consists of two (2) improved, modified control discs, that incorporates (fulcrum pivot mechanics) to be used in the event the operator's hand has arthritis, carpel tunnel, difficulty in closing fingers, fist, or other hand deficiencies, which makes them unable to pull and use our original twine line grab ball control disc, against the heavy force of those springs installed by the manufacturer.

These two (2) improved fulcrum-pivot-design controls will make it very easy for the driver to still open and close the slide gate porthole chute from the driver's seat, because they use (fulcrum physics) less force to move a heavier load.

### CROSS REFERENCE TO RELATED APPLICATIONS

This application claims the benefit of U.S. NON Provisional Allocation Ser. No. 16/780,991 filed on Feb. 4, 2020

This material is a Continuation In Part with application Ser. No. 16/780,991

### BRIEF DESCRIPTION

### Control Disc Improvement: Driver Operated

There are presently 25 tow-behind spreaders that can use our user-installed Tow-Behind Driver Seat Operated Slide Gate Chute Control Hardware Kit, to position the slide gate chute from the drivers' seat. However, there are a few low-end rated spreaders where the manufacturer uses heavy springs, as well as nylon spring-pressured washers to squeeze the lower portion of the original manufactures' spreader handle lever, so when the handle lever is moved, by the user, it stays (put) in that position. This, of course, requires the operator to use much more force on their hand and finger joints to apply enough pressure to move and reposition the slide gate chute. Thus, a person with arthritis or other hand squeezing difficulties may be unable to use our original grab-ball control disc method. To better suit these individuals with hand or finger disabilities, we have designed two (2) alternate control disc methods as a (continuation in part) with improvements that uses a fulcrum, (pivot mechanics) design, which enables the user, from their drivers' seat, to easily compensate for the firm spring tension and pressure applied to the washers on the handle axle, without asserting very much pressure on their fingers, hand joints or similar hand deficiencies, to easily open and close the slide gate chute. For this reason, the improvement of these two Fulcrum Control user-installed kits is used to help the user to apply less force to move a heavy load.

### BRIEF DESCRIPTION OF DRAWINGS

FIG. 1. Controller Type 1: Round pulley and handle lever (Fulcrum Pivot Control)

FIG. 2. Controller Type 2: Long handle with pivot arm (Fulcrum Pivot Control)

FIG. 3. Detailed pulley (Fulcrum Pivot Control) Type 1

FIG. 4. Detailed handle (Fulcrum Pivot Control) Type 2

FIG. 5. Hardware and fastener detailed assembly references

### BRIEF DISCRIPTION—PULLEY-FULCRUM-CONTROL

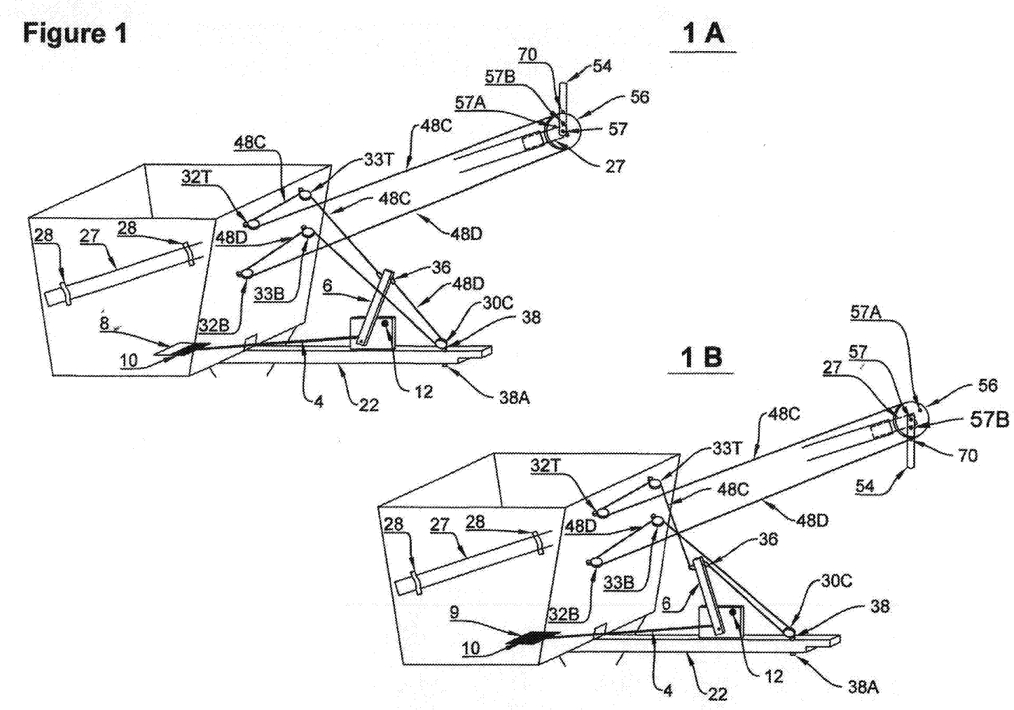

### FIG. 1

The embodiment of this improved control disc device (56) is mounted on the end of our support shaft (27) at the drivers' seat, is comprised of a round disc, with a center groove, much like a pulley, but not limited to a tubular roll, or part of a tubular dish shaped disc or circular shaped object to wrap or coil a preferred nylon twine around, but not limited to, cord, rope, wire, sheathed cable or similar flexible line, that can shorten and lengthen by rotating, pulling or pushing movement to move the twine-line back and forth, but not limited to six (6) inches, has a handle lever attached (54) for the drivers hand to push, using the fulcrum pivot, to rotate the said pulley, which will then pull the said twine through various pulleys, mounted on the spreader, to pull and operate the slide gate discharge chute from the drivers' seat.

### DETAILED DISCRIPTION—PULLEY-FULCRUM-CONTROL

### FIG. 1

“Note”: For clarity, our shaft (27) is not fully shown and the two double pulleys (set 32 and set 33) are separated so it is easier to visualize how the twine-line travels through the double pulleys, mounted on the spreader.

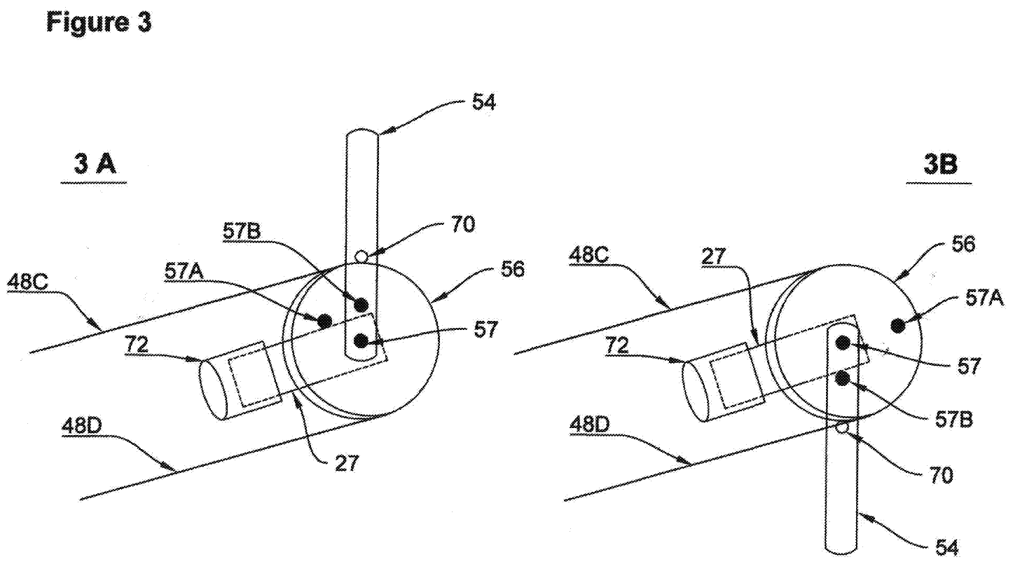

Our support shaft (27) is mounted with straps (28) just as before, to the side of the spreader hopper and places the other end of the shaft and the control pulley (to be easily reached) at the drivers' seat. At the drivers' seat, (DETAIL FIG. 3) is a grooved pulley shaped circular control disc (56) with an attached handle lever (54) comes pre-assembled to the end of our support shaft with a bolt (57), lock washer, nylon washer and non-slip nut. A double swivel pulley (32T) and (32B) FIG. 1, for our twine-line, is bolted to the shaft using a conduit strap, located further down the shaft (27) in line with the front of the plastic hopper. In line with those two double pulleys and fastened to the top of the plastic hopper with screw, lock washer and non-slip nut is an (L) bracket. This (L) bracket connects another set of double swivel pulleys (33T) and (33B). The spreader handle gets a clamp on (36) U bolt with loop rings, so there's no steel to drill. Bolted to the tow bar (22) is an existing bolt (38A) which connects the tow bar to the tractor hitch. We attach an (L) bracket (38) to existing bolt (38A) and mount a single swivel pulley (30C) for our twine (48). For reference; on drawing FIG. 1-A, the slide gate unit (10) has an open slide gate porthole chute (8). And, drawing FIG. 1-B below, the slide gate (10) has a closed slide gate chute (9). The hardware kit components are now all attached to the spreader.

### DETAILED SPECIFICATIONS OF THE INVENTION WITH METHOD OF OPERATION

FIG. 1-A: Lacing of the twine-line (48). First we set the handle lever (6) so that the slide gate chute porthole is open (8) (FIG. 1-A) and the granular product flow adjustment (12) is “fully” open to maximum position. We set fulcrum handle lever (54) FIG. 3A located on control pulley (56) facing upwards, until the stop bolt (57A) rests against the upper portion of our support shaft (27). Our twine line (48C) FIG. 1A is first attached to the shaft mounted control pulley (56) onto a tie off hole (70) located on the fulcrum handle lever (54) that is facing upwards. The other end of that twine-line (48C) proceeds down and around the upper double pulley (32T) mounted on our shaft (27) then over to the upper double pulley (33T) mounted on the spreader top wall and then connects and ties off (with no slack) onto our U-bolt clamp (36) rear facing (loop ring) mounted to the top of handle lever (6) as shown. This handle lever (6) is the original manufacturers' hand-held lever that moves the connecting rod (4) that moves the slide gate chute unit (10) to force the slide gate porthole chute to open and close.

We now take the other new cut end of the twine-line (48D) and tie it to spreader handle lever (6) to our U-bolt clamp (36) to the other front facing (loop ring). The twine-line (48D) continues downward over to the single swivel pulley (30C) located on the tow bar, then returns through the spreader attached lower pulley (33B) then continues over to the lower pulley (32B) attached to our support shaft. After the twine-line (48D) leaves the pulley (32B) it continues freely along the shaft (27) up to, and connects to our fulcrum pulley control disc (56) at the drivers' seat to the same handle (54) tie off hole (70) where the twine-line (48C) originally started from. Our owner's installation instructions will show that the stop pin (57A) FIG. 3A on the control pulley (56) must stay hitting and resting on the top of our support shaft (27) and then the user can pull the twine-line (48D) taught and tie it off. Both ends of the twine-line are tied to the pulley connection hole (70) so the twine does not slip when the pulley is rotated. The twine-line lacing is complete.

The twine-line is attached to all the pulleys and our fulcrum pulley in a continuous loop, whereas, when the fulcrum pulley rotates to pull the twine-line in one direction, it also rotates and release the twine-line in the opposite direction. There is one (1) stop bolt (57A) through the pulley that hits the support shaft when the slide gate (10) porthole chute is open (8) and a pulley-through-bolt (57B) which attaches handle to pulley, is a stop pin as well, when it hits the support shaft (27) when the pulley handle lever (54) is pointed downward and the slide gate (10) porthole chute (9) is closed FIG. 1-B. The stop bolt is primarily used for setting up the twine in the open and closed slide gate position before tying it off onto the pulley hole (70). In FIG. 1-B when the driver chooses to close the slide gate unit (10), they simply move and rotate the fulcrum pulley control handle lever (54) downward FIG. 1-B, and the fulcrum control pulley starts pulling on the twine (48C) which then pulls the spreader handle lever (6) back towards the hopper and the slide gate porthole chute (9) closes. The stop bolts (57A) and (57B) is a precaution to prevent the pulley from over compensating, however, the pulley will not move any farther once the slide gate chute unit (10) is closed (9) or (8) is open. The operator can always adjust the granular products' flow rate.

The operator uses the control pulley (56), with its fulcrum long handle (54) (Fulcrum Pivot Physics) to apply less force to move a heavy load created by the tension of the manufacturer's pressure spring washers. This, of course, reduces pressure to their hand squeezing issues, arthritis, or other finger disabilities when they need to reposition the slide gate porthole chute.

### BRIEF DISCRIPTION HANDLE-PIVOT-FULCRUM CONTROL TYPE 2

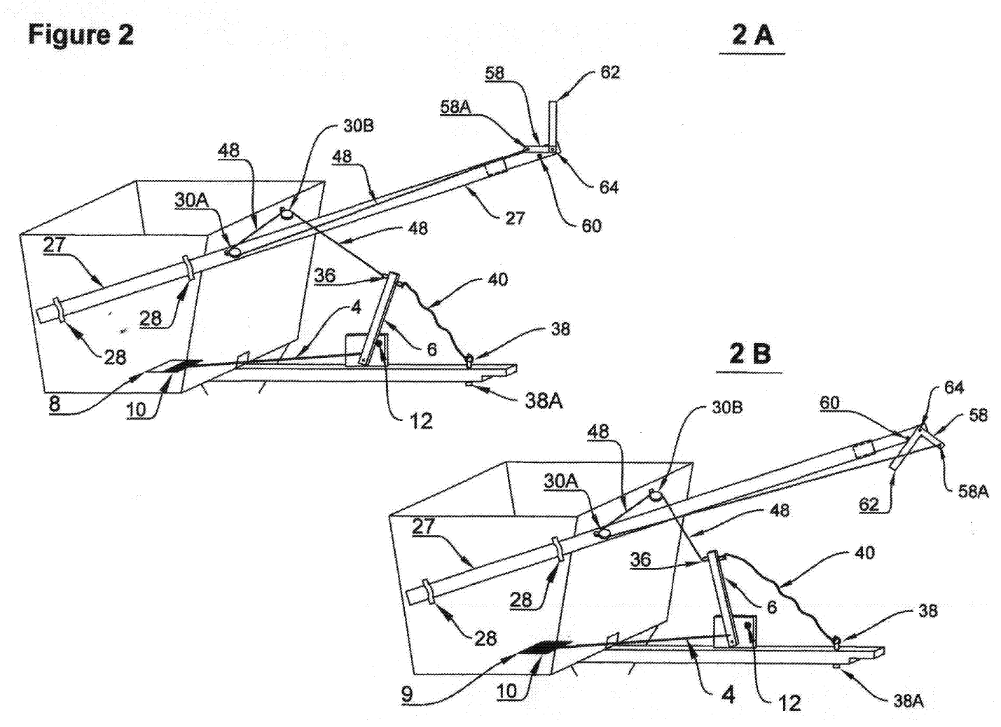

### FIG. 2

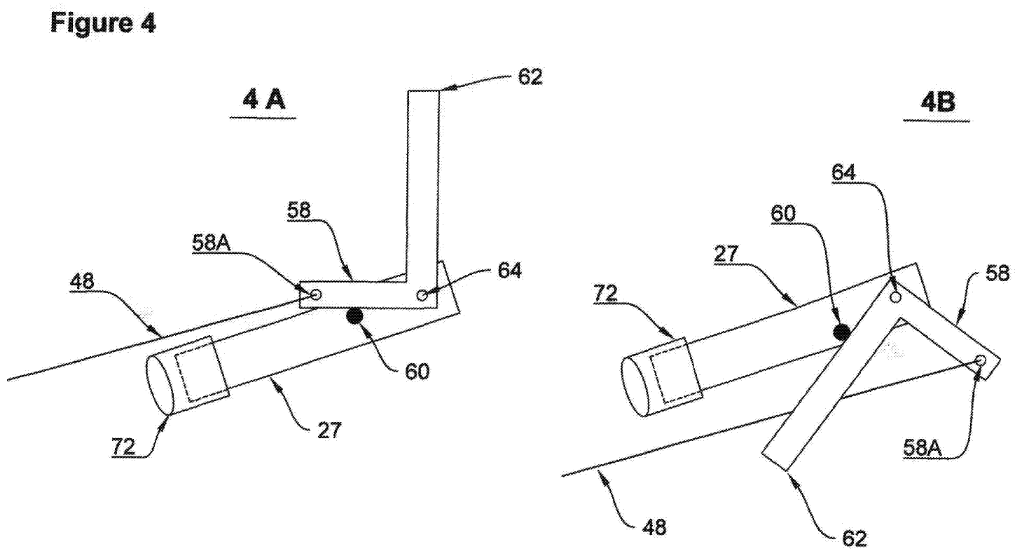

The embodiment for this control handle lever (DETAIL FIG. 4) is comprised of a straight handle (62), preferred to be, but not limited to six (6) inches long with a 90 degree shorter arm (58), preferred to be, but not limited to two 2 inches long in an (L) shaped configuration, where, at their axis point is a pivot bolt (64) that fastens the (L) shaped fulcrum handle lever (62) to the support shaft (27) at the drivers' seat with a bolt, lock washer, nylon washer, and stop nut, which now creates a fulcrum lever to move heavy loads with less force. This embodiment, comprising of a straight handle with an (L) shaped arm, allows a longer length of twine-line to be pulled by the handle lever, because its shape enhances the travel path to produce a longer “throw” to move the slide gate (10) FIG. 2 position back and forth, but is not limited to a straight handle lever, without a 90 degree (L) shaped arm, having the same fulcrum pivot properties, in the same manner, so as to pull enough length of twine or wire to reposition slide gate chute (10). This fulcrum handle control (62) allows the driver to open and close the slide gate chute from the drivers' seat. It is this longer handle lever that they use to pull or release the twine-line that is connected through various pulleys, attached to the spreader, to move the spreaders handle lever (6) that moves the connecting rod (4) that opens and closes the slide gate chute (10). The longer handle lever (62) that pivots, enables the driver to easily move, using fulcrum pivot physics, the shorter 90 degree arm, to pull and release the twine-line in a backwards and forwards movement to create more force to open and close the slide gate unit (10) with less applied effort.

The embodiment of the twine-line is preferred to be multiple stranded nylon twine, being thin, yet strong, to operate smoothly, with directional changes, through all the pulleys, but not limited to a cord, rope, sheathed cable, similar flexible line, or wire that can be pulled, pushed, or wound and released by a pulley, through a loop, or pulled and pushed through a sheath to reposition the slide gate porthole chute. Further, because of the pressured spring-tension washers, on these low-end models, it is sometimes necessary to simultaneously use two (2) small bungee cords, pulling parallel together, so to have enough pulling tension needed to force and pull the spreader handle lever (6), to move the closed porthole chute (9) back to open position (8). Moreover, pulling two bungee springs will be no problem using fulcrum pivot mechanics.

### DETAILED DISCRIPTION HANDLE-PIVOT-FULCRUM CONTROL TYPE 2

### FIG. 2-A

The support shaft (27) is bolted through the spreader plastic hopper with straps (28) bolts, lock washers and stop nuts, so that the handle control lever (62) is next to the driver's seat elbow without anything touching the pulling vehicle. The handle lever, DETAIL FIG. 4 (62) is pre-attached to the support shaft (27) and is facing upwards and the shorter arm (58) is resting on a stop pin (60) that is bolted through the support shaft (27) to prevent the short arm (58) from moving any further. The spreader mounted, handle lever (6) FIG. 2-A, on the tow bar frame (4) is being pulled back from the bungee cord (40) tension that is tied between handle lever (6) U-bolt (36) ring and over to the (L) bracket on the tow bar bolt (38). This FIG. 2A shows the slide gate unit (10) has an open porthole (8). Swivel pulley (30A) is attached to our support shaft (27) with a strap and is in line with swivel pulley (30B) which is fastened with a bolt, washer, and stop nut to the top of the spreader plastic hopper in line with handle lever (6). The kit hardware components are all attached.

### DETAILED SPECIFICATIONS OF THE INVENTION AND METHOD OF OPERATION

### FIG. 2 Method of Operation

Our installation manual will direct the user to open the flow rate setting (12) to its maximum open position and to place the control hand lever (62) at the drivers' seat, in a downward position FIG. 2-B. The lacing of the twine-line (48) begins where one end of the twine-line (48) is first tied off to a small hole (58A) DETAIL FIG. 4B, in the short 90 degree arm (58) attached to control handle (62). The twine-line (48) then continues through the shaft mounted pulley (30A) FIG. 2B then over to spreader mounted pulley (30B) and then over to our U-bolt clamp (36) rear facing (loop ring) on the spreaders handle (6). We then pull “tightly” on the twine-line (48) until the spreader handle lever (6) forces the connecting rod (4) to close the porthole chute (9) FIG. 2B and then tie off the twine-line (48) and cut it. “NOTE” the twine (48) has been pulled real tight now because the stop pin (60) is hitting the long control arm (62) FIG. 2B. The only way the twine-line (48) can get enough slack to move backwards, to open the slide gate chute porthole (8), is when the operator lifts the control handle lever (62) upwards, which pivots the short arm (58) upwards as well, to release enough twine-line (48) to reposition the slide gate chute porthole to open (8) as is FIG. 2-A. It is this bungee cord (40) tension that pulls on the spreader handle lever (6) towards the pulling vehicle, that tugs on the twine-line to pull enough slack backwards, to open the slide gate chute (8) FIG. 2-A.

To simplify this operation: FIG. 2-B The twine-line (48) was pulled tight and tied off between the spreader handle lever (6) and the operator control short pivot arm (58). There is no more twine slack. The slide gate connecting rod (4) cannot move back from the pulling force of the bungee cord (40) because the fulcrum pivot handle lever (62) has been (pinned) (60) to stop, thus the slide gate chute (9) stays closed without any further assistance from the operator. All twine lacing is complete.

Looking at FIG. 2A, the slide gate chute is open (8) and the fulcrum handle (62) is facing upwards. When the driver is ready to close the slide gate unit (10) from their seat, they push downward on the long handed lever FIG. 2-B (62). The twine-line now starts pulling through single swivel pulley (30A) and (30B) and tugs on U-bolt (36) and (loop ring) clamped to spreader handle (6) and starts to force the connecting rod (4) connected to the slide gate unit (10) to push and move the slide gate porthole chute to close (9) FIG. 2-B. Once the small arm (58) pivots and passes the center of the support shaft (27) it hits the stop pin (60) again FIG. 4B. The arm (58) is now forced to stay in that position because the bungee cord (40) is pulling and applying tension on the twine. Thus, the slide gate unit (10) stays in the closed (9) position without any further assistance from the driver. When the driver wants to open the slide gate porthole chute again, FIG. 2A they move the handle lever (62) upward and the slack of the twine-line (48) pulls backwards because of the bungee cord (40) tension. The slack moving backwards, towards the spreader causes spreader handle lever (6) to move the opposite way and forces the slide gate porthole chute to open (8) as in FIG. 2-A. Moreover, handle lever (62), by applying fulcrum pivot physics properties, allows the driver to use less force to move a heavier load, that being, the heavy squeezing tension-washers installed by the manufacturer.

### SUMMARY

All of the “original user installed kit” hardware embodiments and claims, consisting of: the support shaft, straps, L brackets, swivel pulleys, nylon twine, control disc, grab ball, and bungee cord remain the same, which enables the driver to open and close the spreader discharge chute from the driver's seat.

This (Continuation In Part) offers two (2) distinct and very important operator control improvements. That being, the use of fulcrum pivot mechanics, to aid the operator who may have been inflicted with a hand disorder and can no longer move the control disc grab ball controller, due to heavy pressure caused by the manufactured springs, on some of the low end tow-behind spreader models. These two (2) fulcrum pivot hardware user-installed kits can be ordered NEW, or can be substituted to only replace our original grab-ball control disc, on their spreader, at a later date, if the operator experiences deficiencies in their hand and is unable to move past the tight spring pressure-washers, using our original grab ball control disc kit, on their original spreader, or, a “newer” model that they may have recently purchased. And, as claimed before, all of the kits are removable and reusable, with just a minor adjustment.

Further, the embodiment of these two user-installed fulcrum pivot controls will have the option of being fully attached to the support shaft, in a complete, originally ordered kit, or, be ordered separately, as an add-on, which includes the required hardware, “plus” an (added coupling) DETAIL FIG. 4 & FIG. 3, (72) to attach the fulcrum control unit they choose, to easily adapt and mount onto our original support shaft, to replace our original grab ball control disc model.

### SEQUENCE OF OPERATION

### Fulcrum “Pulley” Handle

FIG. 1-A The Control disc handle at the drivers' seat is facing upwards (54) and the slide gate chute porthole is open (8). When the driver wants to close the slide gate porthole chute, and stop the flow of granular product, he merely pushes downward on the handed lever (54) forcing the fulcrum pulley (56) to pull the twine line (48C) downwards FIG. 1-B (clockwise rotation) which closes the slide gate porthole chute closed (9). The slide gate porthole chute remains closed (9) and handle lever (54) remains in a downward position with no more assistance from the operator.

FIG. 1-B When the driver wants to open the slide gate chute porthole, and start the flow of granular product again, they merely pull upwards on the pulley fulcrum handle lever (54) forcing the fulcrum pulley (56) to pull the twine line (48D) upwards FIG. 1-A (counter clockwise rotation) which pulls the spreader handle (6) towards the pulling vehicle, FIG. 1-A which pulls the connecting rod (4) to open the slide gate porthole chute to open (8), with no further assistance from the operator. Both stop pins (57A) and (57B) keep the fulcrum handle (56) from moving and over-rotating too far in both directions.

Thus, to simplify: with the “handle Up” the granular product flows. With the “Handle Down” the granular product flow is halted (stops).

### SEQUENCE OF OPERATION

### Fulcrum “Pivot” Handle

FIG. 2-A The fulcrum control handle lever at the drivers' seat is facing upwards (62) and the slide gate chute porthole is open (8). When the driver wants to close the slide gate porthole chute, and stop the flow of granular product, he merely pushes downward on the fulcrum handed lever (62) forcing the fulcrum handle lever (58) to pull the twine line (48) tied to the short arm hole (58A) forwards and downwards FIG. 2-B which pulls on the spreader handle lever (6) forcing the connecting rod (4) to close the slide gate porthole chute closed (9). The slide gate porthole chute remains closed (9) and handle lever (62) remains in a downward position. The stop pin (60) FIG. 2-B prevents the handle lever (62) from moving any further, in this downward position, and the short fulcrum arm (58) and the twine tie off (58A) stays in place and keeps the twine (48) taught without any further assistance from the operator.

FIG. 2-B When the driver wants to open the slide gate porthole, and start the flow of granular product again, he merely lifts upward on the handed lever (62) forcing the fulcrum handle short arm (58) to pull the twine line (48) tied to the hole (58A) up and around FIG. 2-A. This moves enough twine slack backwards towards the spreader and the slide gate porthole chute tis now open (8). The slide gate porthole chute remains open FIG. 1-A (8) and handle lever (62) remains in an upward position with no more assistance from the operator.

The stop pin (60) keeps the fulcrum handle (62) from moving too far in both directions. Thus, to simplify: with the “handle Up” the granular product flows. With the “Handle Down” the granular product flow is halted (stops).

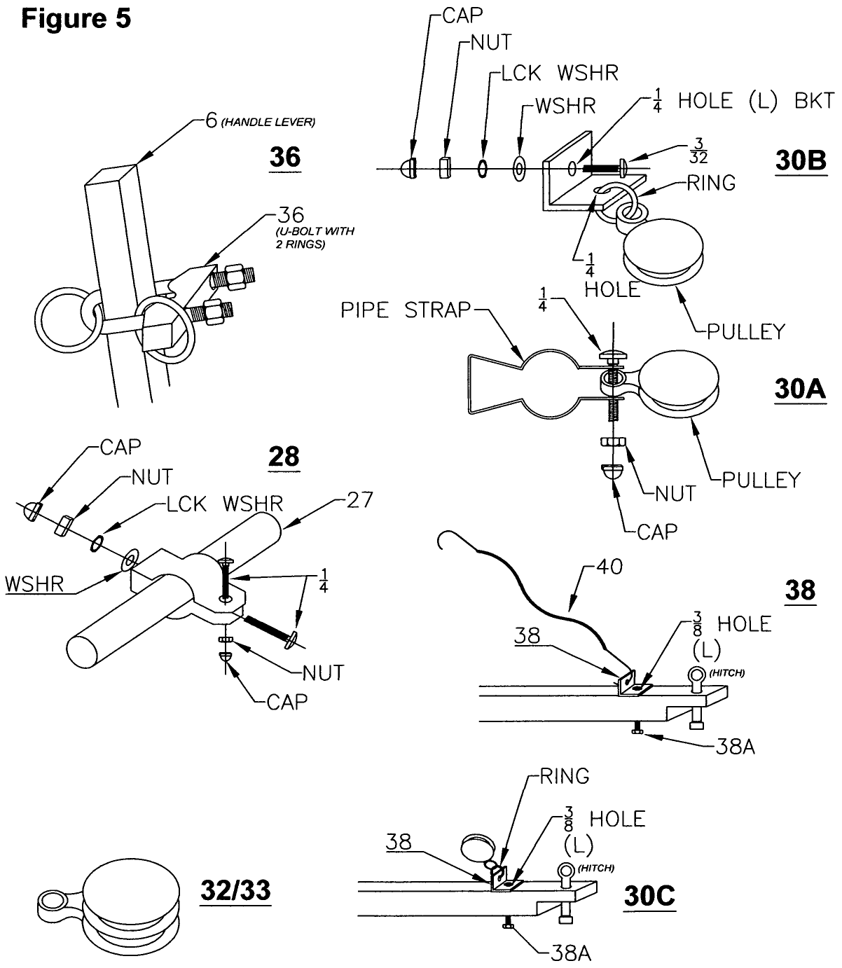

FIG. 5, shows the spreader fastening details that are used in the self-installed kits.

What is being claimed:

1. A claim is made for the embodiment improvements of the fulcrum pulley control kit, which is comprised of a round disc with a center groove 6 inch pulley, to wrap, coil, or pull a preferred nylon twine around that can be shortened and lengthen, by rotating the said pulley to a 90 degrees clockwise and counterclockwise rotational movement that the driver uses to change the length of the said twine-line to make it change the position of the slide gate discharge porthole chute, is mounted on the end of the support shaft at the drivers' seat, whereas,
a) the embodiment of this round circular, pulley is comprised of a preferred shape, so that when it is turned by the driver, it is capable of moving the travel of the twine at least six (6) inches clockwise and counterclockwise, so it provides enough “throw” (travel) to push and pull the spreader handle lever far enough to move the connecting rod that connects to the slide gate mechanism to open and close the slide gate porthole chute, whereas,
b) the embodiment of the attached pulley's control handle lever is comprised of a straight handle that is attached to the circular disc pulley, in such a manner, that when pushed and pulled by the (user) driver, to apply movement of the pulley will turn and change direction of the said pulley at least six (6) inches, thereby, shortening and extending the length of the said twine in such a manner, so as to change position of the spreaders handle lever , and overcome the extra pressure applied by the manufacturer's springs, to open and close the slide gate porthole chute, by using fulcrum pivot mechanics, which uses less force to move a heavier load.

2. A claim is made for the embodiment improvements of the fulcrum pivot handle and arm control kit, which is comprised of a long handle with a 90 degree (L) shorter arm attached to the straight handle lever, mounted onto the end of the support shaft, located at the drivers' seat, that where attached, will cause the other end of the handle to pivot, with enough “throw” (travel) to move the said twine-line six (6) inches, when pushed or pulled by the driver, with a back and forth movement, applied by the operators hand, will cause the shortening and extending of the said twine, in such a manner, so as to change position of the spreaders handle lever , and overcome the extra pressure applied by the manufacturer's springs, to open and close the slide gate porthole chute, by using fulcrum pivot mechanics, which uses less force to move a heavier load.

3. A claim is made, as per claim 1 embodiment of the preferred, double and single twine-line, swivel pulleys, comprising of a smooth loop with grooved channel that will smoothly steer the said twine when needed, to change direction of the twine and thus, subsequently change the position of the slide gate porthole chute, to become open or closed, from the back and forth movement of the spreaders' handle lever.

4. A claim is made, as per claim 1 for the embodiment of the support shaft, comprising of a round pipe, that has stability properties, to limit flexing, where one end is mounted on the tow-behind spreader hopper wall and the other end fastens the fulcrum pivot control unit, so it is reachable next to the drivers' seat, for easy reach and use by the driver while seated, driving and facing forwards.

5. A claim is made, as per claim 1 for the embodiment of the stop pins located on the fulcrum pulley and the fulcrum pivot handle, comprising of a protruding bolt that stops the forward and backward movement of the fulcrum control, so as to make it bottom out, and stop its further rotation and to keep the fulcrum handle from over-turning, which will also stop the twine-line from expanding any further.

6. A claim is made, as per claim 1 that all of the entire parts and hardware for these two (2) improved (fulcrum physics) controllers, is comprised of, a user self-installed kit, that the user installs themselves on new or existing tow-behind spreaders, whereas,
a) the user can also obtain either one of the two (2) fulcrum pivot controls, as a separate item, to attach to their previously ordered kits shaft, which comes with a shaft coupling, that will replace only our original control disc and grab ball, on the end of the support shaft, with the new fulcrum pivot control unit, if they ever experience hand or finger disabilities, where they will still be able to operate the slide gate chute from the driver's seat, to overcome the extra pressure applied by the manufacturers' springs, by just attaching the coupling, retying the twine-line and changing out the single pulley, to a double, if needed.

7. A claim is made, as per claim 6, that the self-installed, hardware fulcrum control kits, never adds, removes, alters, or changes any of the manufacturers' spreader slide gate chute mechanisms, because the twine-line only pulls or pushes the original spreaders' handle lever forwards and backwards, that moves the connecting rod back and forth, that connects to the slide gate chute, that causes it to open and close.

8. A claim is made, as per claim 6, that the installer, mounts the entire kits' hardware components, onto the spreader and nothing ever touches the pulling vehicle, whereas,
a) the same fulcrum control kit can also be pre-assembled by the original manufacturer on newly made tow-behind spreaders.

9. A claim is made, as per claim 6, that these two (2) self-installed, fulcrum control improvement kits, allows the users who have been imposed with hand or finger disorders, to compensate for the heavily factory installed springs, and thereby, the operator is still able to reposition the slide gate porthole chute, from the driver's seat, by using the pivot properties associated with fulcrum pivot mechanics.

10. A claim is made, as per claim 6, that the entire hardware components are manufactured in the form of a self-installed “KIT”, for the installer to use on their tow-behind spreader models that utilize the handle lever/connecting rod/slide gate chute mechanism, whereas,
a) the user can remove the entire kit, and reinstall it on another model (with the same handle lever characteristics) if their original spreader is unusable, and only needs to (if required) adjust the support shaft length to the close proximity of the pulling vehicles seat, and re-tie the twine-line, whereas,
b) the tow-behind spreader's support shaft, with its attached fulcrum pivot control, can be repositioned as well, to fit another pulling vehicle, if their original pulling vehicle is under repair or out of commission, whereas,
c) the support shaft can be mounted to either side of the spreader wall for the drivers left or right handed preference.

11. A claim is made, as per claim 1, for the embodiment of the clamp-on U-Bolt and (loop rings), which benefits the installer, by not having to drill “any steel” to mount hardware and parts to the spreader.
